(19) United States
(12) Patent Application Publication
(10) Pub. No.: US 2007/0120885 A1
(43) Pub. Date: May 31, 2007

(54) METHOD AND DEVICE TO DETECT DEFECTIVE NOZZLE OF WIDE ARRAY HEAD

(76) Inventor: Jin-wook Jeong, Yongin-si (KR)

Correspondence Address: STANZIONE & KIM, LLP, 919 18TH STREET, N.W., SUITE 440, WASHINGTON, DC, 20006, US

(21) Appl. No.: 11/536,765

(22) Filed: Sep. 29, 2006

(30) Foreign Application Priority Data
Nov. 28, 2005 (KR) 2005-114046

(51) Int. Cl. B41J 29/393

(52) U.S. Cl. 347/19

(57) ABSTRACT

A method and device to detect defective nozzles of a wide array head, the method including printing a predetermined test pattern, detecting reflectances of lights of three light sources by scanning the printed predetermined test pattern with the lights of the three light sources, and detecting a defective nozzle using each detected reflectance.

### CROSS-REFERENCE TO RELATED APPLICATIONS

This application claims priority under 35 U.S.C. §119(a) from Korean Patent Application No. 10-2005-0114046, filed on Nov. 28, 2006, in the Korean Intellectual Property Office, the disclosure of which is incorporated herein in its entirety by reference.

### BACKGROUND OF THE INVENTION

1. Field of the Invention

The present general inventive concept relates to an inkjet printer including a wide array head, and more particularly, to a method and a device to detect defective nozzles of a wide array head using a low resolution scanner.

2. Description of the Related Art

A conventional wide array head inkjet printer includes a wide array head having a length corresponding to a width of a print medium, a driving means to print an image on the print medium by driving the wide array head, a controller to control an operation of the driving means to print a first test pattern for detecting a group of nozzles including defective nozzles after dividing the nozzles of the wide array head and a second test pattern for detecting a location of the defective nozzles in the group including the defective nozzles, and a detector to detect the location of the defective nozzles from the first and second test patterns.

The controller controls the first test pattern to include reference indications of a location of each group of nozzles. Here, the reference indications are spaced apart from one another by a predetermined distance in the width direction of the print medium. In addition, the detector includes a light emitter to irradiate the print medium with light and a light receiver to receive the light reflected from the print medium.

According to a predetermined standard, the test patterns are printed, and the defective nozzles are detected by scanning the printed test patterns.

In the inkjet printer including the wide array head, a probability of an occurrence of a defective nozzle in a production process or a user environment is very high, since the wide array head includes tens of thousands of nozzles. For example, in an inkjet printer with a 1200 dpi (dots per inch) print resolution, at least 10,200 nozzles are used per color, and since the wide array head prints 4 colors, e.g., cyan, magenta, yellow, and black, the wide array head has at least 40,800 nozzles.

FIG. 1 is a view illustrating an example of a conventional test pattern used for detecting defective nozzles of a wide array head. In FIG. 1, an image with 1200 dpi resolution is printed at an interval of eight nozzles, which is 1200/8=150 dpi, and eight line groups are formed for each color.

FIG. 2 is a view illustrating another example of a conventional test pattern used for detecting defective nozzles of a wide array head. In FIG. 2, an image with 1200 dpi resolution is printed at an interval of four nozzles, which is 1200/4=300 dpi, and four line groups are formed for each color.

FIG. 3 is a view illustrating another example of a conventional test pattern used for detecting a defective nozzle of a wide array head. In FIG. 3, an image with 1200 dpi resolution is printed at an interval of four nozzles, and line groups are formed for each color of four colors.

When the resolution is 1200 dpi, although an image of a test pattern is formed at 300 dpi and is printed at an interval of four nozzles, a black area occupies 1/1200 dpi, and therefore a real resolution of a scanner is very low. In the above case, when the print image is detected by adjusting a threshold level, a probability of an occurrence of a recognition error caused by noise increases, and therefore a reliability of detecting defective nozzles drops drastically.

In addition, as illustrated in FIG. 3, when an image is formed with each of four colors in an image with 1200 dpi resolution, a length of an image printable in a sub scanning direction is limited when printing an entire test pattern on one page.

In addition, a 1200 dpi scanner is needed for detecting a 1200 dpi test pattern.

### SUMMARY OF THE INVENTION

The present general inventive concept provides a method and a device to detect defective nozzles of a wide array head using a low resolution scanner.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of detecting a defective nozzle of a wide array head, the method including printing a predetermined test pattern, detecting reflectances of the predetermined test pattern with respect to lights of first, second, and third light sources by scanning the printed predetermined test pattern with the lights of the first, second, and third light sources, and detecting a defective nozzle of the wide array head using each detected reflectance.

The foregoing and/or other aspects and utilities of the present general inventive concept may also be achieved by providing a device to detect a defective nozzle of a wide array head, the device including a test pattern detector to detect reflectances of a test pattern scanned with lights of first, second, and third light sources, and a defective nozzle detector to detect a defective nozzle using each detected reflectance.

The foregoing and/or other aspects and utilities of the present general inventive concept may also be achieved by providing a method of detecting a defective nozzle in a printhead, the method including emitting first, second, and third color lights from first, second, and third light sources, respectively, towards a predetermined test pattern including at least one chromatic image, detecting first, second, and third reflectances of the first, second, and third color lights, respectively, reflected from the at least one chromatic image, and determining whether the printhead includes a defective nozzle using the first, second, and third reflectances and a predetermined threshold reflectance.

The determining whether the printhead includes a defective nozzle may include determining that the printhead does not include a defective nozzle when the first, second, and third reflectances are the same and are less than or equal to the predetermined threshold reflectance, and determining that a black nozzle to print a black sub-image of the at least one chromatic image is a defective nozzle when the first, second, and third reflectances are the same and are greater than the predetermined threshold reflectance

The determining whether the printhead includes a defective nozzle may include determining that a color nozzle to print a color sub-image of the at least one chromatic image is a defective nozzle when the first, second, and third reflectances are not the same. The determining whether the printhead includes a defective nozzle may further include determining which of the first, second, and third reflectances has a greatest reflectance value, and determining that a color nozzle to print a color corresponding to the first, second, or third reflectance having the greatest reflectance value is a defective nozzle.

The emitting of the first, second, and third color lights may include emitting the first, second, and third color lights towards a first chromatic image and a second chromatic image, respectively, the detecting of the first, second, and third reflectances may include detecting the first, second, and third reflectances reflected from the first chromatic image, and detecting fourth, fifth, and sixth reflectances reflected from the second chromatic image, and the determining whether the printhead includes a defective nozzle may include determining whether the printhead includes a defective nozzle using the first, second, third, fourth, fifth, and sixth reflectances and first and second predetermined threshold reflectances.

The determining whether the printhead includes a defective nozzle may include determining that a black nozzle to print a black sub-image of the first chromatic image is a defective nozzle when the first and second reflectances are greater than the predetermined threshold reflectance. The determining whether the printhead includes a defective nozzle may include determining that a color nozzle to print a color sub-image of the first chromatic image is a defective nozzle when the first and second reflectances are less than the predetermined threshold reflectance and the third reflectance is greater than the second predetermined threshold reflectance.

The determining whether the printhead includes a defective nozzle may include determining that the printhead does not include a defective nozzle when the first, second, fourth, and fifth reflectances are less than or equal to the predetermined threshold reflectance, and the third reflectance is less than or equal to the second predetermined threshold reflectance. The determining whether the printhead includes a defective nozzle may include determining that a color nozzle to print a color sub-image of the second chromatic image is a defective nozzle when the first and second reflectances are less than the predetermined threshold reflectance, the third reflectance is less than or equal to the second predetermined threshold reflectance, and one of the fourth, fifth, and sixth reflectances corresponding to the color sub-image of the second chromatic image is greater than the predetermined threshold reflectance.

The foregoing and/or other aspects and utilities of the present general inventive concept may also be achieved by providing an apparatus to detect a defective nozzle in a printhead, including first, second, and third light sources to emit first, second, and third color lights, respectively, towards a predetermined test pattern including at least one chromatic image, a test pattern detector to detect first, second, and third reflectances of the first, second, and third color lights, respectively, reflected from the at least one chromatic image, and a defective nozzle detector to determine whether the printhead includes a defective nozzle using the first, second, and third reflectances and a predetermined threshold reflectance.

The defective nozzle detector may determine that the printhead does not include a defective nozzle when the first, second, and third reflectances are the same and are less than or equal to the predetermined threshold reflectance, and may determine that a black nozzle to print a black sub-image of the at least one chromatic image is a defective nozzle when the first, second, and third reflectances are the same and are greater than the predetermined threshold reflectance.

The defective nozzle detector may determine that a color nozzle to print a color sub-image of the at least one chromatic image is a defective nozzle when the first, second, and third reflectances are not the same. The defective nozzle detector may determine which of the first, second, and third reflectances has a greatest reflectance value, and may determine that a color nozzle to print a color corresponding to the first, second, or third reflectance having the greatest reflectance value is a defective nozzle.

The first, second, and third light sources may emit the first, second, and third color lights towards a first chromatic image and a second chromatic image, respectively, the test pattern detector may detect the first, second, and third reflectances reflected from the first chromatic image, and may detect fourth, and fifth reflectances reflected from the second chromatic image, and the defective nozzle detector may determine whether the printhead includes a defective nozzle using the first, second, third, fourth, fifth, and sixth reflectances and the first and second predetermined threshold reflectances.

The defective nozzle detector may determine that a black nozzle to print a black sub-image of the first chromatic image is a defective nozzle when the first and second reflectances are greater than the predetermined threshold reflectance. The defective nozzle detector may determine that a color nozzle to print a color sub-image of the first chromatic image is a defective nozzle when the first and second reflectances are less than the predetermined threshold reflectance and the third reflectance is greater than the second predetermined threshold reflectance.

The defective nozzle detector may determine that the printhead does not include a defective nozzle when the first, second, fourth, and fifth reflectances are less than or equal to the predetermined threshold reflectance, and the third reflectance is less than or equal to the second predetermined threshold reflectance. The defective nozzle detector may determine that a color nozzle to print a color sub-image of the second chromatic image is a defective nozzle when the first and second reflectances are less than the predetermined threshold reflectance, the third reflectance is less than or equal to the second predetermined threshold reflectance, and one of the fourth, fifth, and sixth reflectances corresponding to the color sub-image of the second chromatic image is greater than the predetermined threshold reflectance.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating an example of a conventional test pattern for detecting defective nozzles of a wide array head;

FIG. 2 is a view illustrating another example of a conventional test pattern for detecting defective nozzles of a wide array head;

FIG. 3 is a view illustrating another example of a conventional test pattern for detecting a defective nozzle of a wide array head;

FIG. 4 is a flowchart illustrating a method of detecting defective nozzles of a wide array head, according to an embodiment of the present general inventive concept;

FIG. 5 is a view illustrating an example of a predetermined test pattern;

FIG. 6 is a view illustrating another example of a predetermined test pattern;

FIG. 7 is a view illustrating another example of a predetermined test pattern;

FIG. 8 is a view illustrating another example of a predetermined test pattern;

FIG. 9 is a flowchart illustrating operation 12 of FIG. 4, according to an embodiment of the present general inventive concept;

FIG. 10 is a view illustrating a reflectance of a predetermined test pattern with respect to a first light source illustrated in FIG. 5 in a black and white image;

FIG. 11 is a view illustrating a reflectance of a predetermined test pattern with respect to a second light source illustrated in FIG. 5 in a black and white image;

FIG. 12 is a view illustrating a reflectance of a predetermined test pattern with respect to a third light source illustrated in FIG. 5 in a black and white image;

FIG. 13 is a view illustrating a table of examples of reflectances of a monochromatic image illustrated in FIG. 5 with respect to the first, second, and third light sources;

FIG. 14 is a flowchart illustrating operation 12 of FIG. 4, according to another embodiment of the present general inventive concept;

FIG. 15 is a table illustrating examples of reflectances of first, second, and third light sources with respect to chromatic images illustrated in FIG. 6;

FIG. 16 is a table illustrating examples of reflectances of the first, second, and third light sources with respect to chromatic images illustrated in FIG. 7;

FIG. 17 is a table illustrating examples of reflectances of the first, second, and third light sources with respect to chromatic images illustrated in FIG. 5;

FIG. 18 is a flowchart illustrating operation 14 of FIG. 4, according to an embodiment of the present general inventive concept;

FIG. 19 is a flowchart illustrating operation 14 of FIG. 4, according to another embodiment of the present general inventive concept;

FIG. 20 is a flowchart illustrating operation 14 of FIG. 4, according to another embodiment of the present general inventive concept;

FIG. 21 is a flowchart illustrating operation 14 of FIG. 4, according to another embodiment of the present general inventive concept;

FIG. 22 is a block diagram illustrating a device to detect defective nozzles of a wide array head, according to an embodiment of the present general inventive concept;

FIG. 23 is a block diagram illustrating a test pattern detector of the device of FIG. 22, according to an embodiment of the present general inventive concept;

FIG. 24 is a block diagram illustrating a test pattern detector of the device of FIG. 22, according to another embodiment of the present general inventive concept;

FIG. 25 is a block diagram illustrating a defective nozzle detector of the device of FIG. 22, according to an embodiment of the present general inventive concept;

FIG. 26 is a block diagram illustrating a defective nozzle detector of the device of FIG, 22 according to another embodiment of the present general inventive concept;

FIG. 27 is a block diagram illustrating a defective nozzle detector of the device of FIG. 22, according to another embodiment of the present general inventive concept; and

FIG. 28 is a block diagram illustrating a defective nozzle detector of the device of FIG. 22, according to another embodiment of the present general inventive concept.

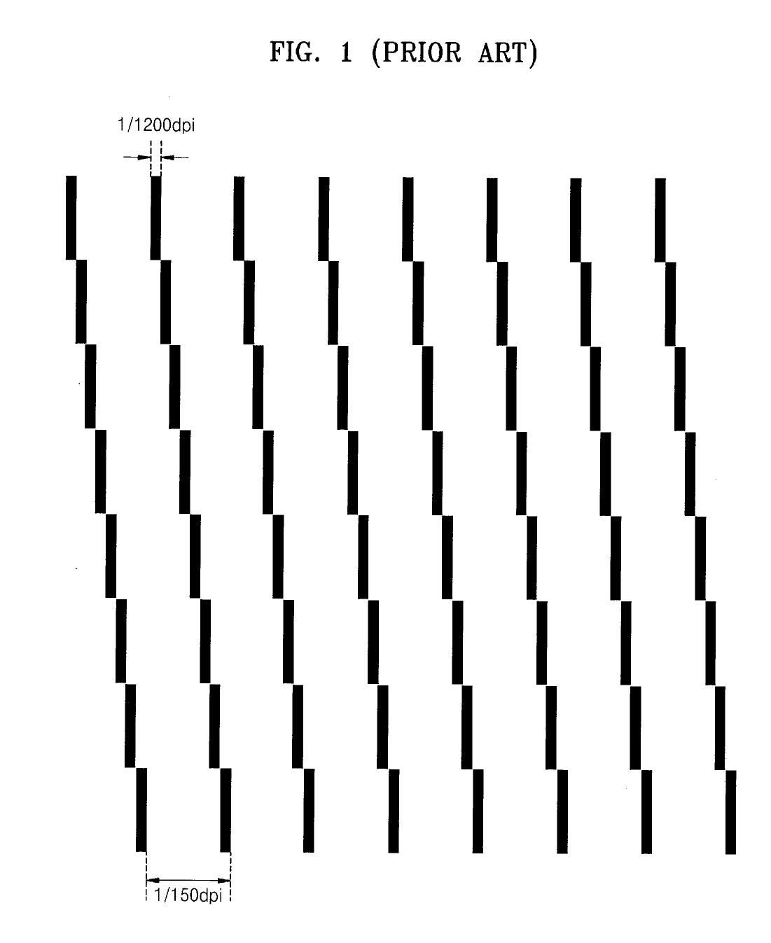

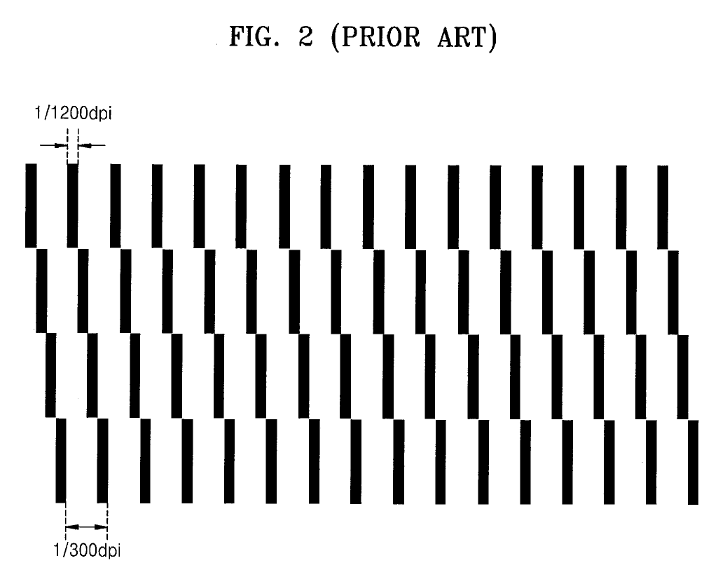

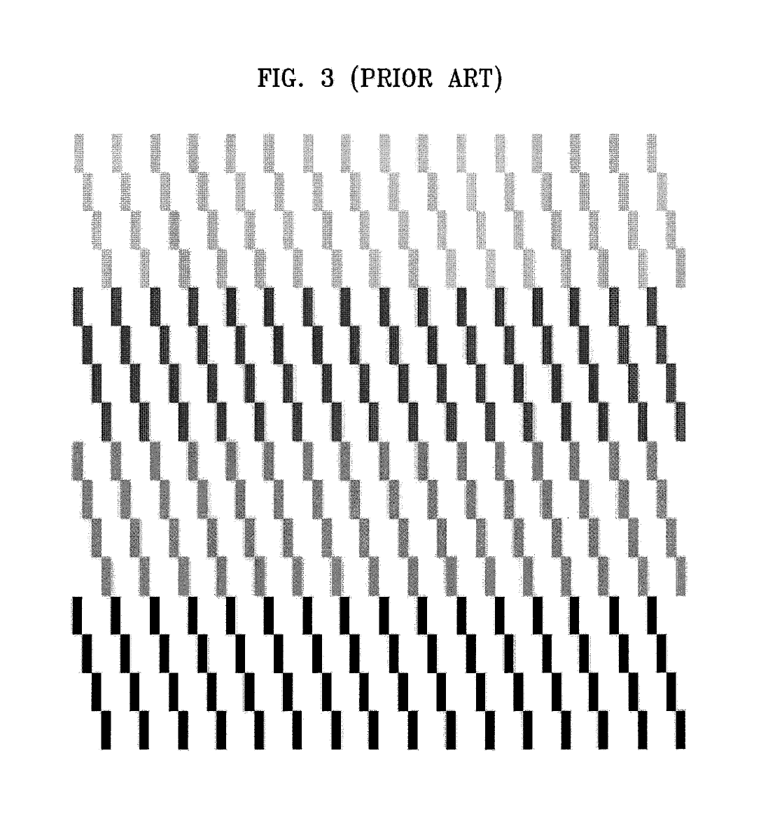

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

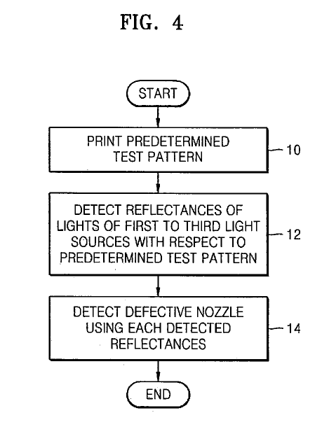

FIG. 4 is a flowchart illustrating a method of detecting defective nozzles of a wide array head according to an embodiment of the present general inventive concept. Referring to FIG. 4, first, a predetermined test pattern is printed (operation 10).

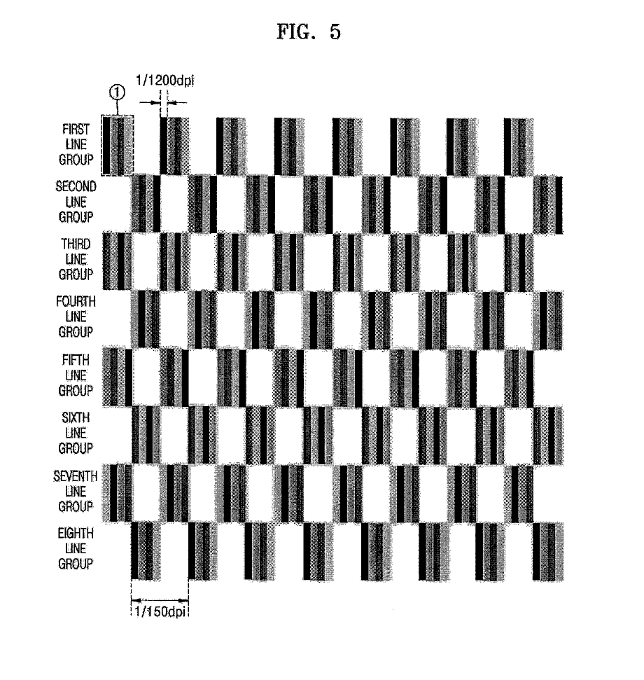

FIG. 5 is a view illustrating an example of a predetermined test pattern. As illustrated in FIG. 5, a chromatic image (1) including four colors, e.g., cyan, magenta, yellow, and black, may be repeated at constant intervals. In addition, when one line group image includes the chromatic image (1) repeatedly printed in a main scanning direction, the predetermined test pattern may include first to eighth line group images. The chromatic images (1) constituting the first to eighth line group images may include cyan, magenta, yellow, and black in different sequences, respectively.

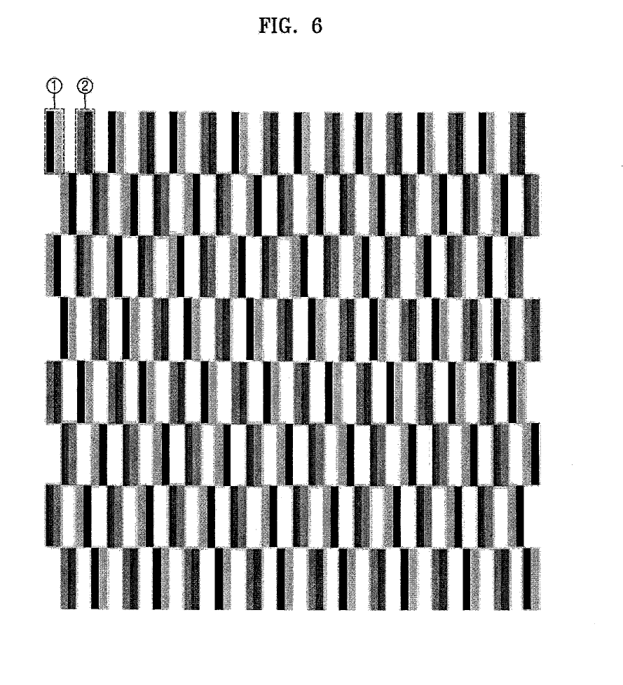

FIG. 6 is a view illustrating another example of a predetermined test pattern. As illustrated in FIG. 6, a chromatic image (1) including, for example, black and yellow, and a chromatic image (2) including, for example, cyan and magenta, may be alternately repeated at constant intervals. In addition, when one line group image includes the chromatic images (1) and (2) repeatedly printed in a main scanning direction, the predetermined test pattern may include first to eighth line group images. The chromatic images (1) and (2) constituting the first to eighth line group images may include cyan, magenta, yellow, and black in different sequences, respectively.

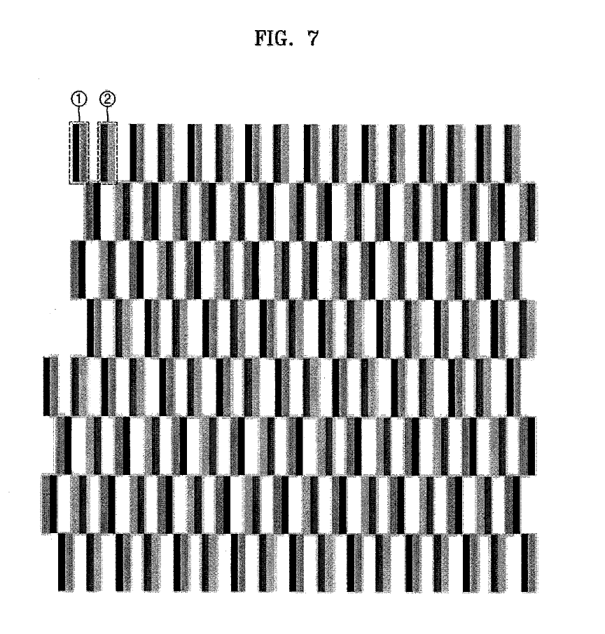

FIG. 7 is a view illustrating another example of a predetermined test pattern. As illustrated in FIG. 7, a chromatic image (1) including, for example, black and cyan, and a chromatic image (2) including, for example, magenta and yellow, may be alternately repeated at constant intervals. In addition, when one line group image includes the chromatic images (1) and (2) repeatedly printed in a main scanning direction, the predetermined test pattern may include first to eighth line group images. The chromatic images (1) and (2) constituting the first to eighth line group images may include cyan, magenta, yellow, and black in different sequences, respectively.

FIG. 8 is a view illustrating another example of a predetermined test pattern. As illustrated in FIG. 8, a chromatic image (1) including, for example, black and magenta, and a chromatic image (2) including, for example, cyan and yellow, may be alternately repeated at constant intervals. In addition, when one line group image includes the chromatic images (1) and (2) repeatedly printed in a main scanning direction, the predetermined test pattern may include first to eighth line group images. The chromatic images (1) and (2) constituting the first to eighth line group images may include cyan, magenta, yellow, and black in different sequences, respectively.

Referring again to FIG. 4, after operation 10, the printed predetermined test pattern is scanned with lights from first, second, and third light sources, and reflectances of the first, second, and third lights are detected (operation 12). For example, when the first light source is a red light source, the second light source is a green light source, and the third light source is a blue light source, the reflectance with respect to each light source is detected by scanning the printed predetermined test pattern with the red, green, and blue lights, respectively.

Hereinafter, the method illustrated in FIG. 4 is described where the first light source is a red light source, the second light source is a green light source, and the third light source is a blue light source. However, the present general inventive concept is not so limited. Thus, the first, second, and third light sources may be different combinations of red, green, and blue light sources. In addition, one or more of the first, second, and third light sources may be colors different from the red, green, and blue light sources.

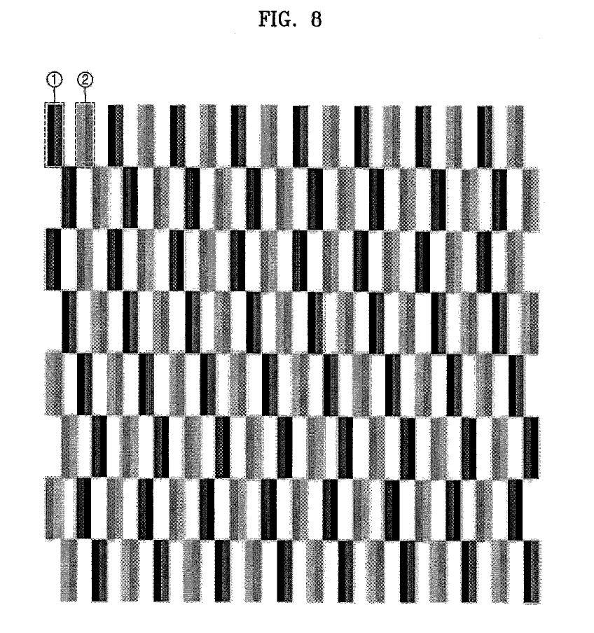

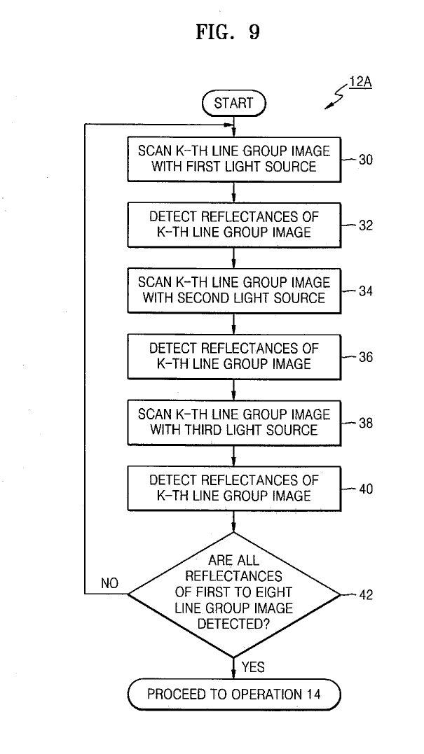

FIG. 9 is a flowchart illustrating operation 12 of FIG. 4 according to an embodiment of the present general inventive concept. Operation 12A illustrated in FIG. 9 represents a method of detecting a reflectance of a predetermined test pattern.

A k-th (k is a positive integer from 1 to 8) line group image is scanned with light from a first light source (operation 30). For example, the first line group image of FIG. 5 may be scanned with light from the first light source.

After operation 30, reflectances of each chromatic image of the k-th line group image with respect to the first light source are detected (operation 32). For example, when the first line group image of FIG. 5 is scanned with light from the first light source, reflectances of the chromatic images included in the first line group image are detected.

When a reflectance of one chromatic image of a line group image with respect to the first light source is detected when the first light source is, for example, a red light source, the reflectance is extremely low since cyan, which is a complementary color of the first light source, mostly absorbs the light from the first light source and since black also mostly absorbs the light from the first light source.

Accordingly, when it is assumed that a maximum of a total reflectance of one chromatic image is 100%, the reflectance of the one chromatic image printed by non-defective nozzles with respect to the first light source is 50% since magenta and yellow mostly reflect the light from the first light source and black and cyan mostly absorb the light from the first light source.

FIG. 10 is a view illustrating a reflectance of a predetermined test pattern illustrated in FIG. 5 with respect to a first light source (red) in a black and white image. As illustrated in FIG. 10, in the case of black and cyan, the image is represented as a black image since black and cyan mostly absorb the light from the first light source (red), and in the case of yellow and magenta, the image is represented as a white image since yellow and magenta mostly reflect the light from the first light source (red).

After operation 32, the k-th line group image is scanned with light from a second light source (operation 34). For example, the first line group image of FIG. 5 may be scanned with light from the second light source.

After operation 34, reflectances of each chromatic image of the k-th line group image with respect to the second light source are detected (operation 36). For example, when a line group image is scanned with light from the second light source, reflectances of chromatic images included in the line group image are detected.

When the reflectance of one chromatic image of a line group image with respect to the second light source is detected when the second light source is, for example, a green light source, the reflectance is extremely low in magenta, which is a complementary color of the second light source. In addition, the reflectance with respect to the second light source in black is also low.

Accordingly, when it is assumed that a maximum of a total reflectance of one chromatic image is 100%, the reflectance of the one chromatic image printed by non-defective nozzles with respect to the second light source is 50% since cyan and yellow mostly reflect the light from the second light source and black and magenta mostly absorb the light from the second light source.

FIG. 11 is a view illustrating a reflectance of a predetermined test pattern illustrated in FIG. 5 with respect to a second light source (green) in a black and white image. As illustrated in FIG. 11, in the case of black and magenta, the image is represented as a black image since black and magenta mostly absorb the light from the second light source (green), and in the case of yellow and cyan, the image is represented as a white image since yellow and cyan mostly reflect the light from the second light source (green).

After operation 36, the k-th line group image is scanned with light from a third light source (operation 38). For example, the first line group image of FIG. 5 may be scanned with light from the third light source.

After operation 38, reflectances of each chromatic image of the k-th line group image with respect to the third light source are detected (operation 40). For example, when a line group image is scanned with light from the third light source, reflectances of chromatic images included in the line group are detected.

When the reflectance of one chromatic image of a line group image with respect to the third light source is detected when the third light source is, for example, a blue light source, the reflectance is extremely low in yellow, which is complementary color of the third light source. In addition, the reflectance with respect to the third light source is low also in black.

Accordingly, when it is assumed that a maximum of a total reflectance of one chromatic image is 100%, the reflectance of the one chromatic image printed by non-defective nozzles with respect to the third light source is 50% since cyan and magenta mostly reflect the light from the third light source and black and yellow mostly absorb the light from the third light source.

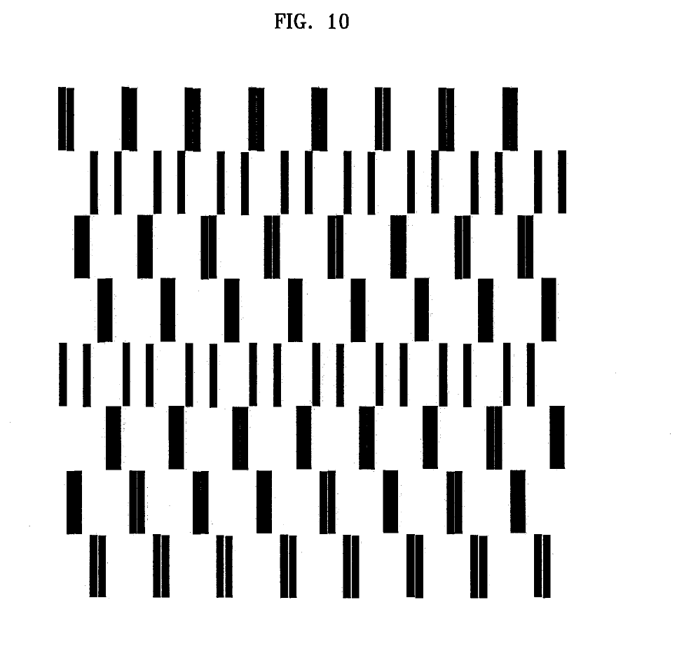

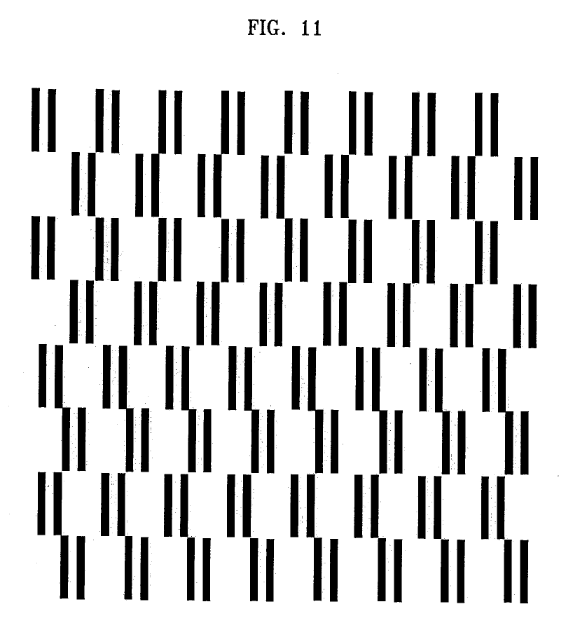

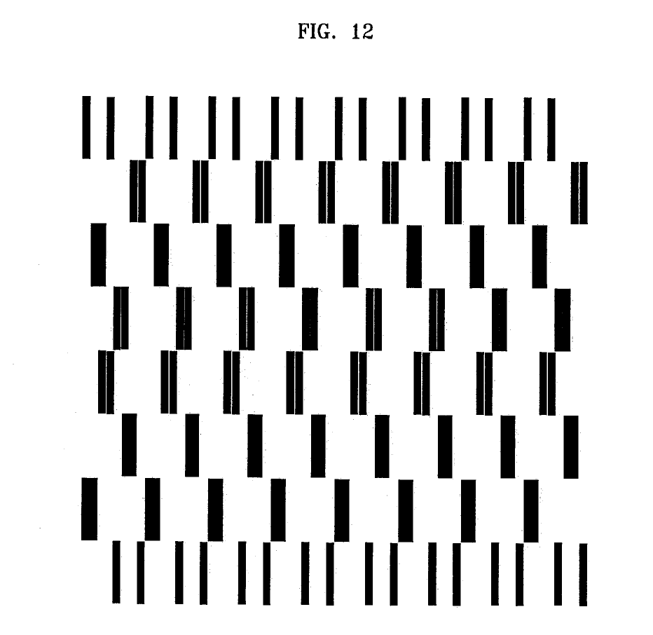

FIG. 12 is a view illustrating a reflectance of a predetermined test pattern illustrated in FIG. 5 with respect to a third light source in a black and white image. As illustrated in FIG. 12, in the case of black and yellow, the image is represented as a black image since black and yellow mostly absorb the light from the third light source, and in the case of magenta and cyan, the image is represented as a white image since magenta and cyan mostly reflect the light from the third light source.

After operation 40, it is determined whether all of the reflectances of each line group, such as the first to eighth line group images of FIG. 5, are detected (operation 42). When all of the reflectances of the first to eighth line group images are not detected, the method illustrated in FIG. 9 returns to operation 30, and operations 30-42 are repeated. Alternatively, when all of the reflectances of the first to eighth line group images are detected, the method illustrated in FIG. 4 proceeds to operation 14.

FIG. 13 is a view illustrating a table including examples of reflectances of first, second, and third light sources (e.g., red, green, and blue light sources) with respect to a monochromatic image illustrated in FIG. 5. The numbers illustrated in FIG. 13 are percentages of the reflectances and represent relative reflectance values (reflectances) when a maximum reflectance is assumed to be 100%.

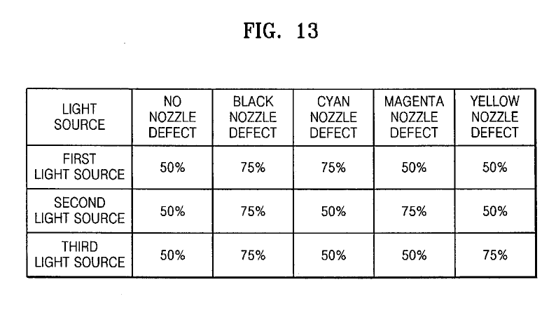

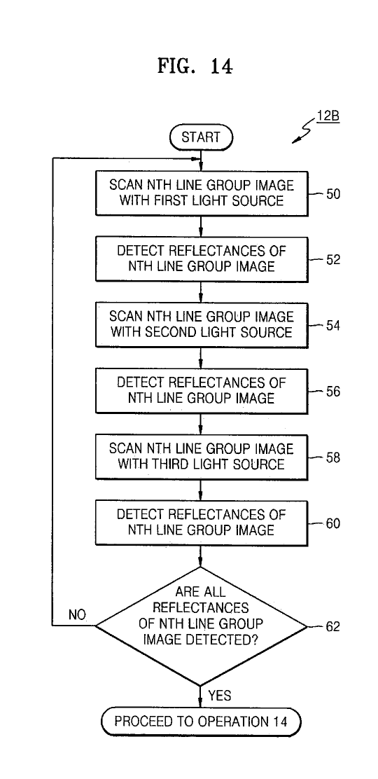

FIG. 14 is a flowchart illustrating operation 12 of FIG. 4 according to another embodiment of the present general inventive concept. Operation 12B of FIG. 14 is a view illustrating operations to detect reflectances for the predetermined test patterns illustrated in FIGS. 6, 7, and/or 8.

The nth (n is a positive integer from 1 to 8) line group image is scanned with light from a first light source (operation 50). For example, the first line group image of FIGS. 6, 7, and/or 8 may be scanned with the light from the first light source.

After operation 50, reflectances of each chromatic image of the nth line group image with respect to the first light source are detected (operation 52). For example, when the first line group image of FIGS. 6, 7, and/or 8 is scanned with the light from the first light source, each reflectance of the chromatic images included in the first line group image is detected.

When the reflectances of the chromatic images (1) and (2) of the first line group image of FIG. 6 with respect to the first light source are detected when the first light source is a red light source, the reflectances are extremely low since the light from the first light source is absorbed in cyan, which is a complementary color of the first light source (red), and since the light from the first (red) light source (red) is also mostly absorbed in black.

Accordingly, when a maximum of a total reflectance of the chromatic image (1) of FIG. 6 is 100%, the reflectance of the chromatic image (1) printed by non-defective nozzles with respect to the first (red) light source is 50% since black mostly absorbs the light from the first light source (red) and yellow mostly reflects the light from the first light source (red). In addition, when a maximum of a total reflectance of the chromatic image (2) of FIG. 6 is 100%, the reflectance of the chromatic image (2) printed by non-defective nozzles with respect to the first light source (red) is 50% since cyan mostly absorbs the light from the first light source (red) and magenta mostly reflects the light from the first light source (red).

After operation 52, the nth (n is equal to or greater than 1 and is equal to or less than 8) line group image is scanned with light from a second light source (operation 54). For example, the first line group image of FIGS. 6, 7, and/or 8 may be scanned with the light from the second light source.

After operation 54, reflectances of each chromatic image of the nth line group image with respect to the second light source are detected (operation 56). For example, when the first line group image of FIGS. 6, 7, and/or 8 is scanned with light from the second light source, the reflectances of the chromatic images included in the first line group image are detected.

When the reflectances of the chromatic images (1) and (2) of the first line group image of FIG. 6 with respect to the second light source are detected when the second light source is a green light source, the reflectances are extremely low since the light from the second light source (green) is absorbed in magenta, which is a complementary color of the second light source, and since the light from the second light source (green) is also mostly absorbed in black.

Accordingly, when the maximum of the total reflectance of the chromatic image (1) of FIG. 6 is 100%, the reflectance of the chromatic image (1) printed by non-defective nozzles with respect to the second light source (green) is 50% since black mostly absorbs the light from the second light source (green) and yellow mostly reflects the light from the second light source (green). In addition, when the maximum of the total reflectance of the chromatic image (2) is 100%, the reflectance of the chromatic image (2) printed by the non-defective nozzles with respect to the second light source is 50% since cyan mostly reflects the light from the second light source (green) and magenta mostly absorbs the light from the second light source (green).

After operation 56, the nth (n is equal to or greater than 1 and is equal to or less than 8) line group image is scanned with a third light source (operation 58). For example, the first line group image of FIGS. 6, 7, and/or 8 may be scanned with the third light source.

After operation 58, reflectances of each chromatic image of the nth line group image with respect to the third light source are detected (operation 60). For example, when the first line group image of FIGS. 6, 7, and/or 8 is scanned with the third light source, the reflectances of the chromatic images included in the first line group image are detected.

When the reflectances of the chromatic images (1) and (2) of the first line group image of FIG. 6 with respect to the third light source are detected when the third light source is a blue light source, the reflectances are extremely low since the light from the third light source (blue) is absorbed in yellow, which is a complementary color of the third light source, and since the light from the third light source (blue) is also mostly absorbed in black.

Accordingly, when a maximum of a total reflectance of the chromatic image (1) is 100%, the reflectance of the chromatic image (1) printed by non-defective nozzles with respect to the third light source is 0% since black mostly absorbs the light from the third light source (blue) and yellow mostly absorbs the light from the third light source (blue). In addition, when a maximum of a total reflectance of the chromatic image (2) is 100%, the reflectance of the chromatic image (2) printed by non-defective nozzles with respect to the third light source is 100% since cyan mostly reflects the light from the third light source (blue) and magenta mostly reflects the light from the third light source (blue).

After operation 60, it is determined whether all of the reflectances of the line group images, such as the first to eighth line group images of FIG. 6, are detected (operation 62). When all the reflectances of the first to eighth line group images are not detected, the method of FIG. 14 returns to operation 50, and the operations 50-60 are repeated. When all the reflectances of the first to eighth line group images are detected, the method of FIG. 4 proceeds to operation 14.

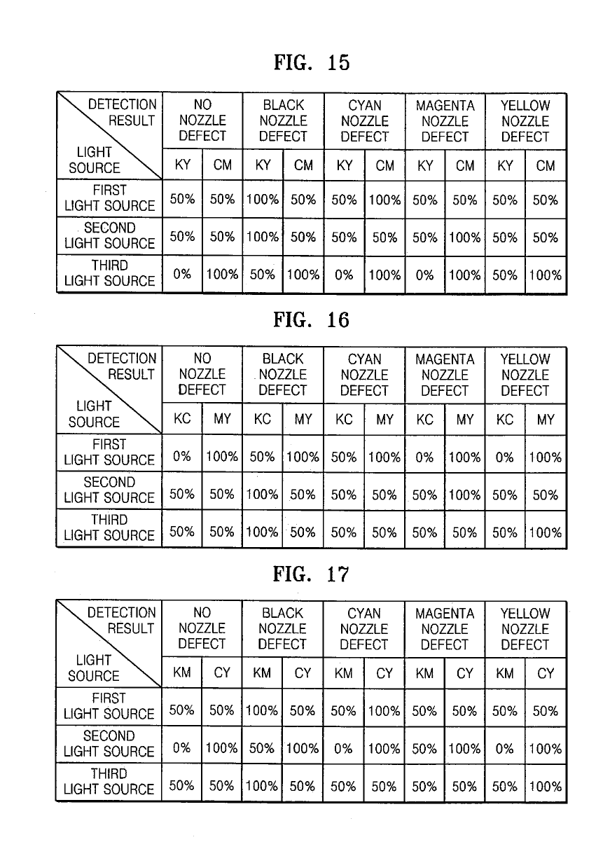

FIG. 15 is a view illustrating a table including examples of reflectances of first, second, and third light sources (e.g., red, green, and blue light sources) with respect to the chromatic images illustrated in FIG. 6. The numbers illustrated in FIG. 15 are percentages of the reflectances, and represent relative reflectance values (reflectances) when a maximum reflectance is assumed to be 100%.

FIG. 16 is a view illustrating a table including examples of reflectances of first, second, and third light sources (e.g., red, green, and blue light sources) with respect to the chromatic images illustrated in FIG. 7. The numbers illustrated in FIG. 16 are percentages of the reflectances, and represent relative reflectance values (reflectances) when a maximum reflectance is assumed to be 100%.

FIG. 17 is a view illustrating a table including examples of reflectances of first, second, and third light sources (e.g., red, green, and blue light sources) with respect to the chromatic images illustrated in FIG. 5. The numbers illustrated in FIG. 17 are percentages of the reflectances, and represent relative reflectance values (reflectances) when a maximum reflectance is assumed to be 100%.

Referring to FIG. 4, after operation 12, defective nozzles are detected using the reflectances detected in operation 12 (operation 14).

When the first light source is a red light source, the second light source is a green light source, and the third light source is a blue light source, the reflectance with respect to the first light source is the lowest in cyan (which is a complementary color of the first light source), the reflectance with respect to the second light source is the lowest for magenta (which is a complementary color of the second light source), and the reflectance with respect to the third light source is the lowest for yellow (which is a complementary color of the third light source). The defective nozzles are detected using each detected reflectance based on the aforementioned complementary color principle.

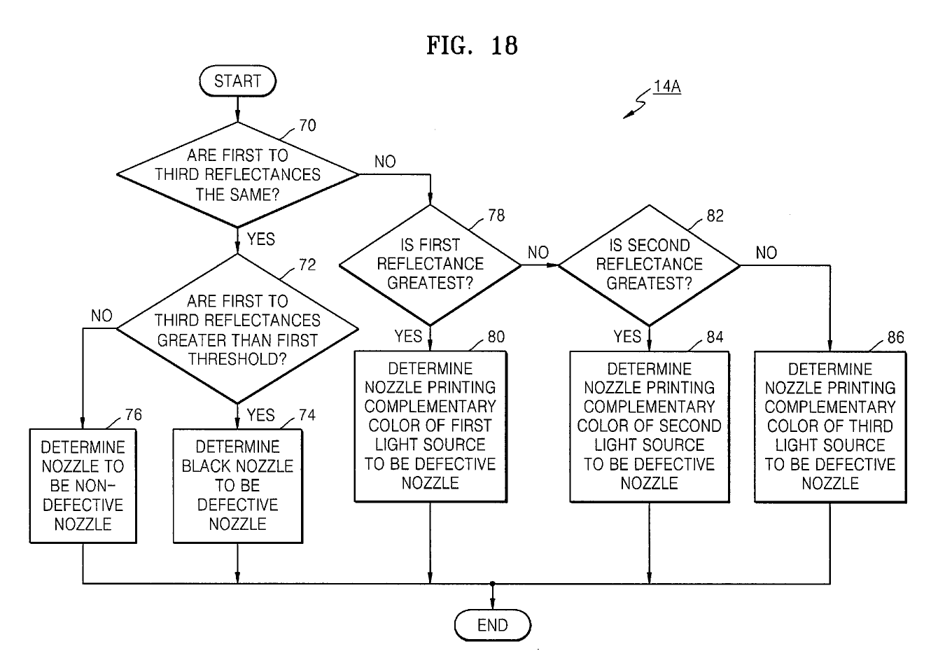

FIG. 18 is a flowchart illustrating operation 14 of FIG. 4 according to an embodiment of the present general inventive concept. Operation 14A of FIG. 18 is described with reference to the predetermined test pattern of FIG. 5.

When a reflectance of a chromatic image with respect to a first light source is a first reflectance, a reflectance with respect to a second light source is a second reflectance, and a reflectance with respect to a third light source is a third reflectance, it is determined whether the first, second, and third reflectances are the same (operation 70).

When the first, second, and third reflectances are the same in operation 70, it is determined whether the first to third reflectances (which as the same) are greater than a first threshold reflectance (operation 72). For example, as illustrated in FIG. 13, when the first, second, and third reflectances for the chromatic image are each 50%, it is determined whether the first, second, and third reflectances of 50% are greater than the first threshold reflectance. Similarly, as illustrated in FIG. 13, when the first, second, and third reflectances for any chromatic image are each 75%, it is determined whether the first, second, and third reflectances of 75% are greater than the first threshold reflectance. The first threshold reflectance may be, for example, 50%.

When the first, second, and third reflectances (which are the same) are determined to be greater than the first threshold reflectance in operation 70, a black nozzle to print black of the chromatic image is determined to be a defective nozzle (operation 74).

For example, when the first threshold reflectance is 50% and the first, second, and third reflectances are 75% (as illustrated in FIG. 13), since the first, second, and third reflectances of 75% are greater than the first threshold reflectance of 50%, a black nozzle to print black of the chromatic image is determined to be a defective nozzle. Since the black color, which absorbs the light from the first, second, and third light sources, is not printed due to the defect of the black nozzle, the first, second, and third reflectances are detected to be 75% (i.e., less light is absorbed and more light is reflected, resulting in the higher reflectance higher than the first threshold reflectance).

When the first, second, and third reflectances (which are the same) are determined to be equal to or less than the first threshold reflectance in operation 72, nozzles to print the chromatic image are determined to be non-defective nozzles (operation 76).

For example, when the first threshold reflectance is 50% and the first, second, and third reflectances (which are the same) are 50% (as illustrated in FIG. 13), since the first, second, and third reflectances are less than the first threshold reflectance, nozzles to print the chromatic image are determined to be non-defective nozzles.

On the other hand, in operation 70, when the first, second, and third reflectances are not the same, it is determined whether the first reflectance is greater than each of the second and third reflectances (operation 78).

When the first reflectance is determined to be greater than each of the second and third reflectances in operation 78, a nozzle to print a complementary color of the first light source of the chromatic image is determined to be a defective nozzle (operation 80).

For example, as illustrated in FIG. 13, when the first reflectance is 75% and the second and third reflectances are 50%, since the first reflectance is greater than the second and third reflectances, a nozzle to print a complementary color of the first light source is determined to be a defective nozzle. For example, when a reflectance of 75% is detected when a chromatic image is scanned with light from a first light source that is a red light source, a chromatic image of cyan, which is a complementary color of the first light source, is not printed, and therefore a nozzle to print the chromatic image of cyan is determined to be a defective nozzle.

When the first reflectance is determined not to be greater than each of the second and third reflectances in operation 78, it is determined whether the second reflectance is greater than each of the first and third reflectances (operation 82).

When the second reflectance is determined to be greater than each of the first and third reflectances in operation 82, a nozzle to print a complementary color of the second light source of the chromatic image is determined to be a defective nozzle (operation 84).

For example, as illustrated in FIG. 13, when the first and third reflectances are 50% and the second reflectance is 75%, since the second reflectance is greater than the first and third reflectances, a nozzle to print a complementary color of the second light source is determined to be the defective nozzle. For example, when a reflectance of 75% is detected when a chromatic image is scanned with light from a second light source that is a green light source, a chromatic image including magenta, which is a complementary color of the second light source, is not printed, and therefore a nozzle to print the chromatic image including magenta is determined to be a defective nozzle.

When the second reflectance is determined not to be greater than the first and third reflectances in operation 82, a nozzle to print a complementary color of the third light source of the chromatic image is determined to be a defective nozzle (operation 86).

For example, as illustrated in FIG. 13, when the first and second reflectances are 50% and the third reflectance is 75%, since the third reflectance is greater than the first and second reflectances, a nozzle to print a complementary color of the third light source is determined to be a defective nozzle. For example, when a reflectance of 75% is detected when a chromatic image is scanned with light from a third light source that is a blue light source, a chromatic image including yellow, which is a complementary color of the third light source, is not printed and therefore a nozzle to print the chromatic image including yellow is determined to be a defective nozzle.

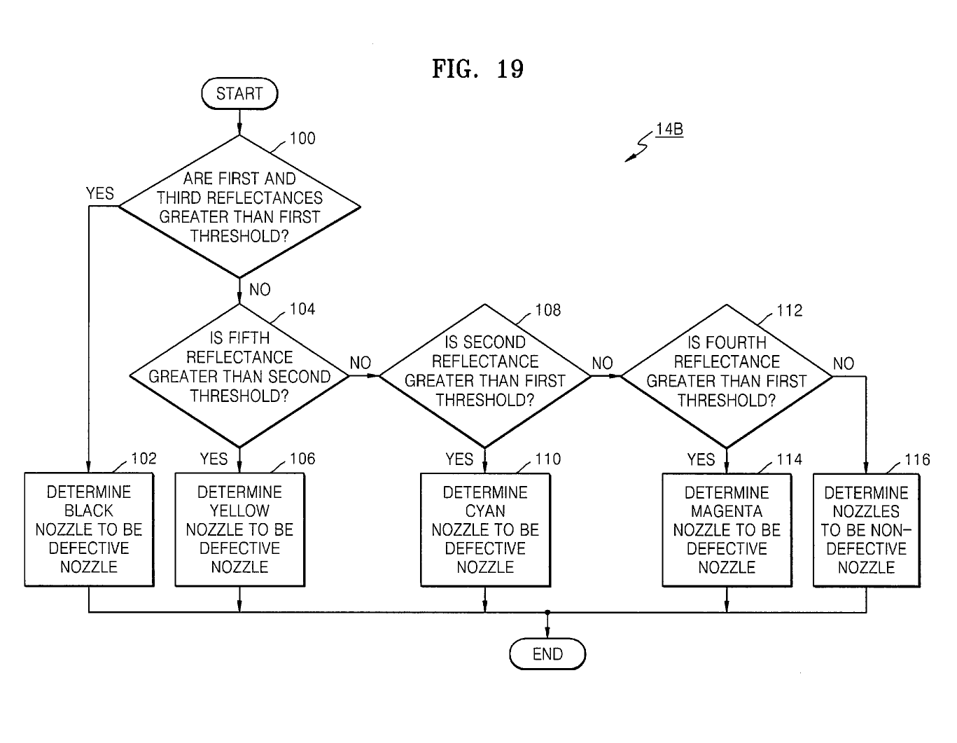

FIG. 19 is a flowchart illustrating operation 14 of in FIG. 4 according to another embodiment of the present general inventive concept. Operation 14B of FIG. 19 is described with reference to the predetermined test pattern of FIG. 6.

Referring to FIG. 6, black and yellow form chromatic image (1), and cyan and magenta form chromatic image (2). When a reflectance of the chromatic image (1) with respect to the first light source is a first reflectance, a reflectance of the chromatic image (2) with respect to the first light source is a second reflectance, a reflectance of the chromatic image (1) with respect to the second light source is a third reflectance, a reflectance of the chromatic image (2) with respect to the second light source is a fourth reflectance, a reflectance of the chromatic image (1) with respect to the third light source is a fifth reflectance, and a reflectance of the chromatic image (2) with respect to the third light source is a sixth reflectance, it is determined whether the first and third reflectances are greater than a first threshold reflectance (operation 100). The first threshold reflectance may be, for example, 75%.

When the first and third reflectances are determined to be greater than the first threshold reflectance in operation 100, a black nozzle to print black of the chromatic image (1) including black and yellow is determined to be a defective nozzle (operation 102).

As illustrated in FIG. 15, when the first and third reflectances are 100% and the first threshold reflectance is 75%, since the first and third reflectances are greater than the first threshold reflectance, the black nozzle to print black is determined to be a defective nozzle. That is, while the reflectances of the first and second light sources are detected to be 50% for non-defective nozzles, since the black color is not printed due to the defect of the black nozzle, the reflectances of the first and second light sources with respect to the chromatic image (1) including black and yellow are detected to be 100%.

When either or both of the first and third reflectances are determined to be equal to or less than the first threshold reflectance in operation 100, it is determined whether the fifth reflectance is greater than a second threshold reflectance (operation 104). The second threshold reflectance may be, for example, 25%.

When the fifth reflectance is determined to be greater than the second threshold reflectance in operation 104, a yellow nozzle to print yellow of the chromatic image (1) including black and yellow is determined to be a defective nozzle (operation 106).

For example, as illustrated in FIG. 15, when the fifth reflectance is 50% and the second threshold reflectance is 25%, since the fifth reflectance is greater than the second threshold reflectance, the yellow nozzle to print yellow is determined to be a defective nozzle. That is, while the reflectance with respect to the third light source is detected to be 0% for non-defective nozzles, since the yellow color is not printed due to the defect of the yellow nozzle, the reflectance of the chromatic image including black and yellow with respect to the third light source is detected to be 50%.

When the fifth reflectance is determined to be equal to or less than the second threshold reflectance in operation 104, it is determined whether the second reflectance is greater than the first threshold reflectance(operation 108).

When the second reflectance is determined to be greater than the first threshold reflectance in operation 108, a cyan nozzle to print cyan of the chromatic image (2) including cyan and magenta is determined to be a defective nozzle (operation 110).

For example, referring to FIG. 15, when the second reflectance is 100% and the first threshold reflectance is 75%, since the second reflectance is greater than the first threshold reflectance, the cyan nozzle to print cyan is determined to be a defective nozzle. That is, while the reflectance with respect to the first light source is detected to be 50% for non-defective nozzles, since cyan is not printed due to the defect of the cyan nozzle, the reflectance of the chromatic image (2) including cyan and magenta with respect to the first light source is detected to be 100%.

When the second reflectance is determined to be equal to or less than the first threshold reflectance in operation 108, it is determined whether the fourth reflectance is greater than the first threshold reflectance (operation 112).

When the fourth reflectance is determined to be greater than the first threshold reflectance in operation 112, a magenta nozzle to print magenta of the chromatic image (2) including cyan and magenta is determined to be a defective nozzle (operation 114).

For example, referring to FIG. 15, when the fourth reflectance is 100% and the first threshold reflectance is 75%, since the fourth reflectance is greater than the first threshold reflectance, the magenta nozzle to print magenta is determined to be a defective nozzle. That is, while the reflectance with respect to the second light source is detected to be 50% for non-defective nozzles, since magenta is not printed due to the defect of the magenta nozzle, the reflectance of the chromatic image (2) including cyan and magenta with respect to the second light source is detected to be 100%.

When the fourth reflectance is determined to be equal to or less than the first threshold reflectance in operation 112, nozzles to print the chromatic image (1) and the chromatic image (2) are determined to be non-defective nozzles (operation 116).

For example, when the fourth reflectance is 50% and the first threshold is 75%, since the fourth reflectance is equal to or less than the first threshold reflectance, nozzles to print the chromatic image are determined to be non-defective nozzles. By performing the method of FIG. 19, it can be determined that each reflectance of the chromatic image is a value corresponding to a non-defective nozzle, and the nozzles to print the chromatic image can be determined to be non-defective nozzles.

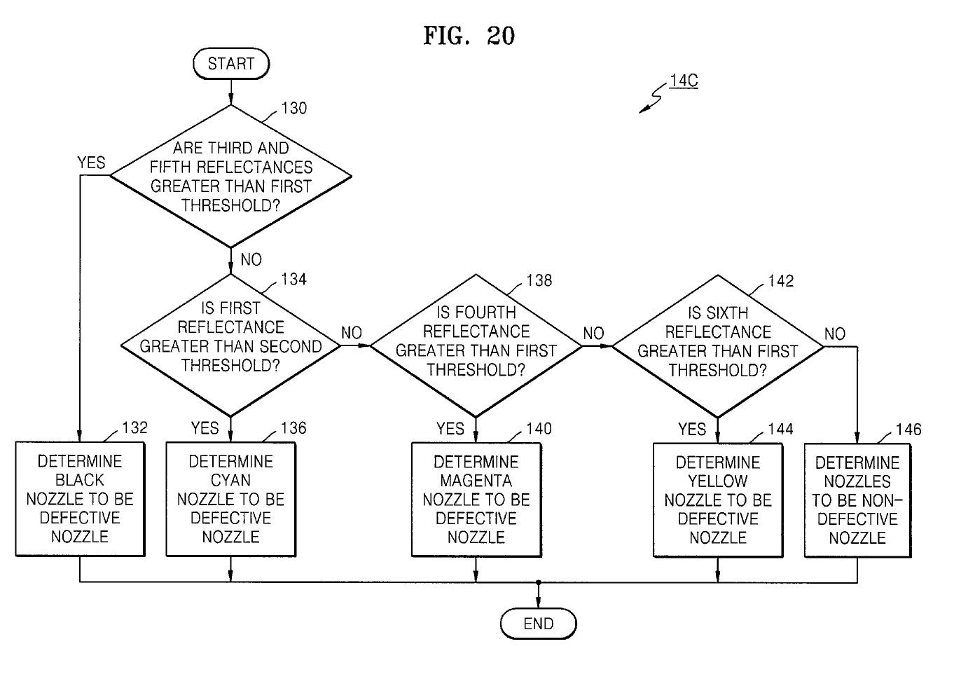

FIG. 20 is a flowchart illustrating operation 14 of FIG. 4 according to another embodiment of the present general inventive concept. Operation 14C of FIG. 20 is described with reference to the predetermined test pattern of FIG. 7.

Referring to FIG. 7, black and cyan form chromatic image (1), and yellow and magenta form chromatic image (2). When it is assumed that a reflectance of the chromatic image (1) with respect to a first light source is a first reflectance, a reflectance of the chromatic image (2) with respect to the first light source is a second reflectance, a reflectance of the chromatic image (1) with respect to a second light source is a third reflectance, a reflectance of the chromatic image (2) with respect to the second light source is a fourth reflectance, a reflectance of the chromatic image (1) with respect to a third light source is a fifth reflectance, and a reflectance of the chromatic image (2) with respect to the third light source is a sixth reflectance, it is determined whether the third and fifth reflectances are greater than a first threshold reflectance (operation 130). The first threshold reflectance can be, for example, 75%.

When the third and fifth reflectances are determined to be greater than the first threshold reflectance in operation 130, a black nozzle to print black of the chromatic image (1) including black and cyan is determined to be a defective nozzle (operation 132).

As illustrated in FIG. 16, when the third and fifth reflectances are 100% and the first threshold reflectance is 75%, since the third and fifth reflectances are greater than the first threshold reflectance, a black nozzle to print black is determined to be a defective nozzle. That is, while the reflectances of the second and third light sources are detected to be 50% for non-defective nozzles, since the black color is not printed due to the defect of the black nozzle, the reflectances of the second and third light sources with respect to the chromatic image (1) including black and cyan are detected to be 100%.

When either or both of the third and fifth reflectances are determined to be equal to or less than the first threshold reflectance in operation 130, it is determined whether the first reflectance is greater than a second threshold reflectance (operation 134). The second threshold reflectance may be, for example, 25%.

When the first reflectance is determined to be greater than the second threshold reflectance in operation 134, a cyan nozzle to print cyan of the chromatic image (1) including black and cyan is determined to be a defective nozzle (operation 136).

For example, referring to FIG. 16, when the first reflectance is 50% and the second threshold reflectance is 25%, since the first reflectance is greater than the second threshold reflectance, the cyan nozzle to print cyan is determined to be a defective nozzle. That is, while the reflectance with respect to the first light source is detected to be 0% for non-defective nozzles, since the cyan color is not printed due to the defect of the cyan nozzle, the reflectance of the chromatic image (1) including black and cyan with respect to the first light source is detected to be 50%.

When the first reflectance is determined to be equal to or less than the second threshold reflectance in operation 134, it is determined whether the fourth reflectance is greater than the first threshold reflectance (operation 138).

When the fourth reflectance is greater than the first threshold reflectance, a magenta nozzle to print magenta of the chromatic image (2) including yellow and magenta is determined to be a defective nozzle (operation 140).

For example, referring to FIG. 16, when the fourth reflectance is 100% and the first threshold reflectance is 75%, since the fourth reflectance is greater than the first threshold reflectance, the magenta nozzle to print magenta is determined to be a defective nozzle. That is, while the reflectance with respect to the second light source is detected to be 50% for non-defective nozzles, since magenta is not printed due to the defect of the magenta nozzle, the reflectance of the chromatic image (2) including yellow and magenta with respect to the second light source is detected to be 100%.

When the fourth reflectance is determined to be equal to or less than the first threshold reflectance in operation 138, it is determined whether the sixth reflectance is greater than the first threshold reflectance (operation 142).

When the sixth reflectance is greater than the first threshold reflectance, a yellow nozzle to print yellow of the chromatic image (2) including yellow and magenta is determined to be a defective nozzle (operation 144).

For example, referring to FIG. 16, when the sixth reflectance is 100% and the first threshold reflectance is 75%, since the sixth reflectance is greater than the first threshold reflectance, the yellow nozzle to print yellow is determined to be a defective nozzle. That is, while the reflectance with respect to the third light source is detected to be 50% for non-defective nozzles, since the yellow color is not printed due to the defect of the yellow nozzle, the reflectance of the chromatic image (2) including yellow and magenta with respect to the third light source is detected to be 100%.

When the sixth reflectance is determined to be equal to or less than the first threshold reflectance in operation 142, nozzles to print the chromatic image (1) and the chromatic image (2) are determined to be non-defective nozzles (operation 146).

For example, referring to FIG. 16, when the sixth reflectance is 50% and the first threshold reflectance is 75%, since the sixth reflectance is equal to or less than the first threshold reflectance, nozzles to print the chromatic images (1) and (2) are determined to be non-defective nozzles. By performing the method of FIG. 20, it can be determined that each reflectance of the chromatic images (1) and (2) is a value corresponding to a non-defective nozzle. Therefore, nozzles used to print the chromatic image can be determined to be non-defective nozzles.

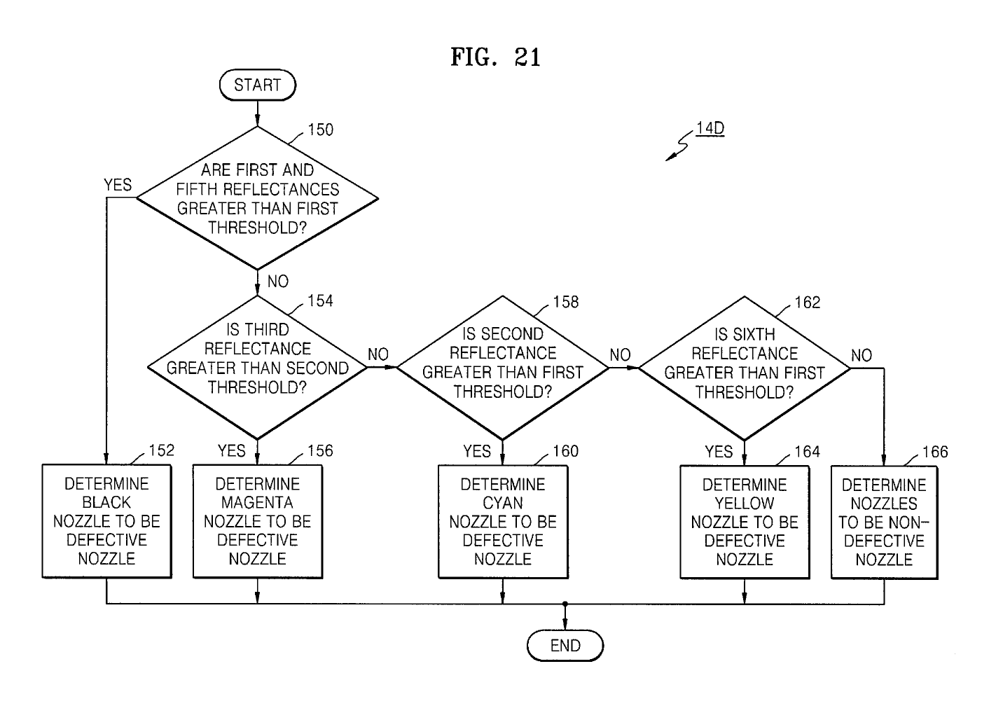

FIG. 21 is a flowchart illustrating operation 14 of FIG. 4 according to another embodiment of the present general inventive concept. Operation 14D of FIG. 21 is described with respect to the predetermined test pattern of FIG. 8.

Referring to FIG. 8, black and magenta form chromatic image (1), and cyan and yellow form chromatic image (2). When a reflectance of the chromatic image (1) with respect to a first light source is a first reflectance, a reflectance of the chromatic image (2) with respect to the first light source is a second reflectance, a reflectance of the chromatic image (1) with respect to a second light source is a third reflectance, a reflectance of the chromatic image (2) with respect to the second light source is a fourth reflectance, a reflectance of the chromatic image (1) with respect to a third light source is a fifth reflectance, and a reflectance of the chromatic image (2) with respect to the third light source is a sixth reflectance, it is determined whether the first and fifth reflectances are greater than a first threshold reflectance (operation 150). The first threshold may be, for example, 75%.

When the first and fifth reflectances are determined to be greater than the first threshold reflectance in operation 150, a black nozzle to print black of the chromatic image (1) including black and magenta is determined to be a defective nozzle (operation 152).

As illustrated in FIG. 17, when the first and fifth reflectances are 100% and the first threshold reflectance is 75%, since the first and fifth reflectances are greater than the first threshold reflectance, a black nozzle to print black is determined to be a defective nozzle. That is, while the reflectances of the first and third light sources are detected to be 50% for non-defective nozzles, since black is not printed due to the defect of the black nozzle, the reflectances of the first and third light sources with respect to the chromatic image (1) including black and magenta are detected to be 100 %.

When either or both of the first and fifth reflectances are determined to be equal to or less than the first threshold reflectance in operation 150, it is determined whether the third reflectance is greater than a second threshold reflectance (operation 154). The second threshold reflectance may be, for example, 25%.

When the third reflectance is determined to be greater than the second threshold reflectance, a magenta nozzle to print magenta of the chromatic image (1) including black and magenta is determined to be a defective nozzle (operation 156).

For example, referring to FIG. 17, when the third reflectance is 50% and the second threshold reflectance is 25%, since the third reflectance is greater than the second threshold reflectance, a magenta nozzle to print magenta is determined to be a defective nozzle. That is, while the reflectance with respect to the second light source is detected to be 0% non-defective nozzles, since magenta is not printed due to the defect of the magenta nozzle, the reflectance of the chromatic image (1) including black and magenta with respect to the second light source is detected to be 50%.

When the third reflectance is determined to be equal to or less than the second threshold reflectance in operation 154, it is determined whether the second reflectance is greater than the first threshold reflectance (operation 158).

When the second reflectance is determined to be greater than the first threshold reflectance in operation 158, a cyan nozzle to print cyan of the chromatic image (2) including cyan and yellow is determined to be a defective nozzle (operation 160).

For example, referring to FIG. 17, when the second reflectance is 100% and the first threshold reflectance is 75%, since the second reflectance is greater than the first threshold reflectance, a cyan nozzle to print cyan is determined to be a defective nozzle. That is, while the reflectance with respect to the first light source is detected to be 50% for non-defective nozzles, since cyan is not printed due to the defect of the cyan nozzle, the reflectance of the chromatic image (2) including cyan and yellow with respect to the first light source is detected to be 100%.

When the second reflectance is determined to be equal to or less than the first threshold reflectance in operation 158, it is determined whether the sixth reflectance is greater than the first threshold reflectance (operation 162).

When the sixth reflectance is determined to be greater than the first threshold reflectance in operation 162, a yellow nozzle to print yellow of the chromatic image (2) including cyan and yellow is determined to be a defective nozzle (operation 164).

For example, referring to FIG. 17, when the sixth reflectance is 100% and the first threshold reflectance is 75%, since the sixth reflectance is greater than the first threshold reflectance, a yellow nozzle to print yellow is determined to be a defective nozzle. That is, while the reflectance with respect to the third light source is detected to be 50% for non-defective nozzles, since yellow is not printed due to the defect of the yellow nozzle, the reflectance of the chromatic image (2) including cyan and yellow with respect to the third light source is detected to be 100%.

When the sixth reflectance is determined to be equal to or less than the first threshold reflectance in operation 162, nozzles to print the chromatic image (1) and the chromatic image (2) are determined to be non-defective nozzles (operation 166).

For example, referring to FIG. 17, when the sixth reflectance is 50% and the first threshold reflectance is 75%, since the sixth reflectance is equal to or less than the first threshold reflectance, nozzles to print the chromatic image are determined to be non-defective nozzles. By performing the method of FIG. 21, it can be determined that each reflectance of the chromatic images (1) and (2) is a value corresponding to a non-defective nozzle. Therefore, nozzles printing the chromatic images (1) and (2) can be determined to be non-defective nozzles.

Methods according to embodiments of the general inventive concept can be embodied as computer readable codes/instructions/programs and can be implemented in general-use digital computers that execute the codes/instructions/programs using a medium, for example, a computer readable recording medium. Examples of the computer readable recording medium include magnetic storage media (e.g., ROM, floppy disks, hard disks, etc.), optical recording media (e.g., CD-ROMs, or DVDs), and storage media, such as carrier waves (e.g., transmission through the Internet). Furthermore, methods according to embodiments of the present general inventive concept can be embodied as mediums including the computer readable codes so the computer readable recording mediums are distributed over network coupled computer systems and executed in a distributed fashion. Also, functional programs, codes, and code segments to perform methods according to embodiments of the present general inventive concept can be easily constructed by programmers skilled in the art to which the present general inventive concept pertains.

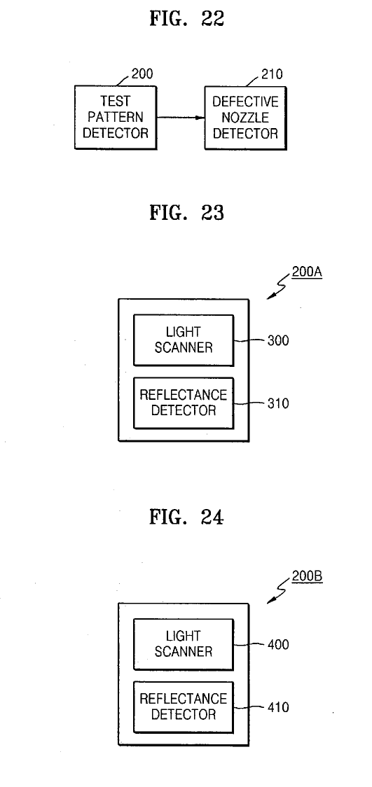

FIG. 22 is a block diagram illustrating a device to detect defective nozzles of a wide array head according to an embodiment of the present general inventive concept. The device to detect defective nozzles includes a test pattern detector 200 and a defective nozzle detector 210.

The test pattern detector 200 detects reflectances of first second, and third light sources by scanning a printed predetermined test pattern with lights from the first, second, and third light sources and outputs detection results to the defective nozzle detector 210.

As illustrated in FIG. 5, the chromatic image (1) including cyan, magenta, yellow, and black may be repeated at constant intervals. In addition, when one line group image is the image in which the chromatic image (1) is repeatedly printed in a main scanning direction, the predetermined test pattern includes first to eighth line group images. The chromatic images (1) constituting the first to eighth line group images may include cyan, magenta, yellow, and black in different sequences.

In addition, as illustrated in FIG. 6, the chromatic image (1) including black and yellow and the chromatic image (2) including cyan and magenta may be alternately repeated at constant intervals. In addition, when one line group image is the image in which the chromatic images (1) and (2) are repeatedly printed in a main scanning direction, the predetermined test pattern includes first to eighth line group images. The chromatic images (1) and (2) constituting the first to eighth line group images may include cyan, magenta, yellow, and black in different sequences.

In addition, as illustrated in FIG. 7, the chromatic image (1) including black and cyan and the chromatic image (2) including magenta and yellow may be alternately repeated at constant intervals. In addition, when one line group image is the image in which the chromatic images (1) and (2) are repeatedly printed in a main scanning direction, the predetermined test pattern includes first to eighth line group images. The chromatic images (1) and (2) constituting the first to eighth line group images may include cyan, magenta, yellow, and black in different sequences.

As illustrated in FIG. 8, the chromatic image (1) including black and magenta and the chromatic image (2) including cyan and yellow may be alternately repeated at constant intervals. In addition, when one line group image is the image in which the chromatic images (1) and (2) are repeatedly printed in a main scanning direction, the predetermined test pattern includes first to eighth line group images. The chromatic images (1) and (2) constituting the first to eighth line group images may include cyan, magenta, yellow, and black in different sequences.

FIG. 23 is a block diagram illustrating the test pattern detector 200 of in FIG. 22 according to an embodiment of the present general inventive concept. Test pattern detector 200A illustrated in FIG. 23 includes a light scanner 300 and a reflectance detector 310 to detect reflectances of lights of the first, second, and third light sources with respect to the predetermined test pattern illustrated in FIG. 5.

The light scanner 300 scans a predetermined test pattern with the lights of the first, second, and third light sources, respectively. For example, the light scanner 300 may scan the predetermined test pattern of FIG. 5, with a red light corresponding to the first light source, a green light corresponding to the second light source, and a blue light corresponding to the third light source.

The reflectance detector 310 detects each reflectance in which the light from the first, second, and third light sources is reflected from the predetermined test pattern, such as the predetermined test pattern of FIG. 5.

FIG. 24 is a block diagram illustrating the test pattern detector 200 of FIG. 22 according to another embodiment of the present general inventive concept. Test pattern detector 200B includes a light scanner 400 and a reflectance detector 410 to detect reflectances of lights of first, second, and third light sources with respect to a predetermined test pattern, such as the predetermined test pattern illustrated in FIGS. 6, 7, and/or 8.

The light scanner 400 scans a predetermined test pattern with the lights of the first, second, and third light sources. For example, the light scanner 400 may scan the predetermined test pattern illustrated in FIGS. 6, 7, and/or 8 with a red light corresponding to the first light source, a green light corresponding to the second light source, and a blue light corresponding to the third light source.

The reflectance detector 410 detects each reflectance when the lights from the first, second, and third light sources are reflected from the predetermined test pattern, such as the predetermined test pattern illustrated in FIGS. 6, 7, and/or 8.

The defective nozzle detector 210 detects a defective nozzle using each detected reflectance.

When the first light source is the red light source, the second light source is the green light source, and the third light source is the blue light source, the reflectance with respect to the first light source is the lowest in cyan (which is a complementary color of the first light source), the reflectance with respect to the second light source is the lowest for magenta (which is a complementary color of the second light source), and the reflectance with respect to the third light source is the lowest for yellow (which is a complementary color of the third light source). The defective nozzle detector 210 detects defective nozzles using each detected reflectance based on the aforementioned complementary color principle.

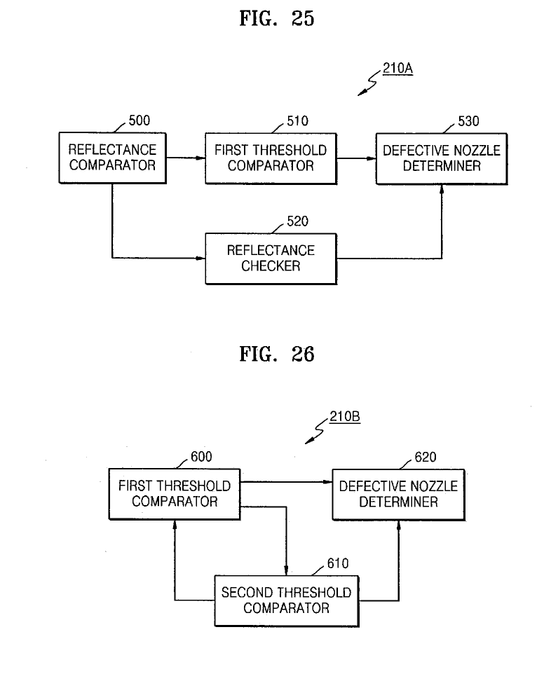

FIG. 25 is a block diagram illustrating the defective nozzle detector 210 of FIG. 22 according to an embodiment of the present general inventive concept. Defective nozzle detector 210A includes a reflectance comparator 500, a first threshold comparator 510, a reflectance checker 520, and a defective nozzle determiner 530.

When a reflectance of a chromatic image with respect to a first light source is a first reflectance, a reflectance with respect to a second light source is a second reflectance, and a reflectance with respect to a third light source is a third reflectance, the reflectance comparator 500 determines whether the first, second, and third reflectances are the same and outputs the result of the determination to the first threshold comparator 510 and the reflectance checker 520.

The reflectance comparator 500 determines whether the first, second, and third reflectances are greater than a first threshold reflectance when it is determined by the reflectance comparator 500 that the first to third reflectances are the same, and outputs the result of the determination to the defective nozzle determiner 530. The first threshold reflectance may be, for example, 50%.

The defective nozzle determiner 530 determines that a black nozzle to print black of chromatic images is a defective nozzle when the first threshold comparator 510 determines that the first, second, and third reflectances are greater than the first threshold reflectance.

In addition, the defective nozzle determiner 530 determines that nozzles to print the chromatic image are non-defective nozzles when the first threshold comparator 510 determines that the first, second, and third reflectances are less than the first threshold reflectance.

On the other hand, the reflectance checker 520 determines whether the first reflectance is greater than the second and third reflectances when the reflectance comparator 500 determines that the first to third reflectances are not the same and outputs the result of the determination to the defective nozzle determiner 530.

The defective nozzle determiner 530 determines that a nozzle to print a complementary color of a first light source of any chromatic image to be a defective nozzle when the reflectance checker 520 determines that the first reflectance is greater than the second and third reflectances.

On the other hand, when the first reflectance is not greater than the second and third reflectances, the defective nozzle determiner 530 determines whether the second reflectance is greater than the first and third reflectances and outputs the result of the determination to the defective nozzle determiner 530.

The defective nozzle determiner 530 determines that the nozzle to print a complementary color of the second light source of the chromatic image to be a defective nozzle when the reflectance checker 520 determines that the second reflectance is greater than the first and third reflectances.

On the other hand, the defective nozzle determiner 530 determines that a nozzle to print a complementary color of the second light source of the chromatic image to be a defective nozzle when the reflectance checker 520 determines that the second reflectance is greater than the first and third reflectances.

FIG. 26 is a block diagram illustrating a defective nozzle detector of FIG. 22 according to another embodiment of the present general inventive concept. Defective nozzle detector 210B includes a first threshold comparator 600, a second threshold comparator 610, and a defective nozzle determiner 620.

Black and yellow may form a first chromatic image, and cyan and magenta may form a second chromatic image. When a reflectance of the first chromatic image including black and yellow with respect to a first light source is a first reflectance, a reflectance of the second chromatic image including cyan and magenta with respect to the first light source is a second reflectance, a reflectance of the first chromatic image including black and yellow with respect to a second light source is a third reflectance, a reflectance of the chromatic image including cyan and magenta with respect to the second light source is a fourth reflectance, a reflectance of the first chromatic image including black and yellow with respect to a third light source is a fifth reflectance, and a reflectance of the second chromatic image including cyan and magenta with respect to the third light source is a sixth reflectance, the first threshold comparator 600 determines whether the first and third reflectances are greater than a first threshold reflectance and outputs the result of the determination to the second threshold comparator 610 and the defective nozzle determiner 620. The first threshold reflectance may be, for example, 75%.

The defective nozzle determiner 620 determines that a black nozzle to print black of the first chromatic image including black and yellow is a defective nozzle when the first threshold comparator 600 determines that the first to third reflectances are greater than the first threshold reflectance.

On the other hand, the reflectance comparator 610 determines whether the fifth reflectance is greater than a second threshold reflectance when the when first threshold comparator 600 determines that either or both of the first to third reflectances are equal to or less than the first threshold reflectance, and outputs the result of the determination to the first threshold comparator 600 and the defective nozzle determiner 620. The second threshold reflectance may be, for example, 25%.

The defective nozzle determiner 620 determines a yellow nozzle to print yellow of the first chromatic image including black and yellow is a defective nozzle when the second threshold comparator 620 determines that the fifth reflectance is greater than the second threshold reflectance.

In addition, the first threshold comparator 600 determines whether the second reflectance is greater than the first threshold reflectance when the second threshold comparator 610 determines that the fifth reflectance is equal to or less than the second threshold reflectance and outputs the result of the determination to the defective nozzle determiner 620.

The defective nozzle determiner 620 determines that a cyan nozzle to print cyan of the second chromatic image including cyan and magenta is a defective nozzle when the first threshold comparator 600 determines that the second reflectance is greater than the first threshold reflectance.

On the other hand, the first threshold comparator 600 determines whether the fourth reflectance is greater than the first threshold reflectance when the first threshold comparator 600 determines that the second reflectance is equal to or less than the first threshold reflectance and outputs the result of the determination to the defective nozzle determiner 620.

The defective nozzle determiner 620 determines that a magenta nozzle to print magenta of the second chromatic image including cyan and magenta is a defective nozzle when the first threshold comparator 600 determines that the fourth reflectance is greater than the first threshold reflectance.

The defective nozzle determiner 620 determines that the nozzles to print the first chromatic image including black and yellow and the second chromatic image including cyan and magenta are not defective nozzles when the first threshold comparator 600 determines that the fourth reflectance is equal to or less than the first threshold reflectance.

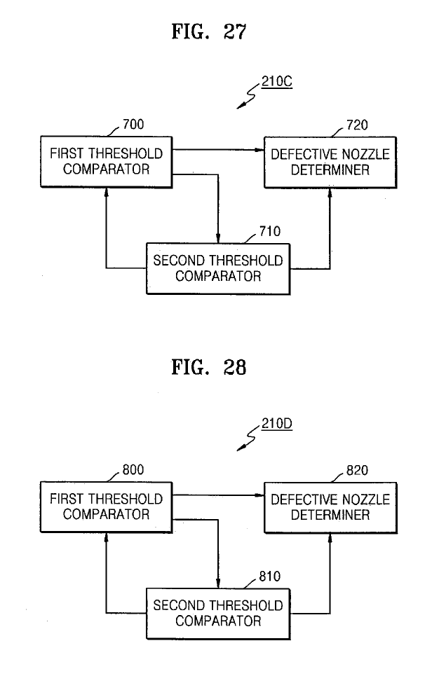

FIG. 27 is a block diagram illustrating the defective nozzle detector 210 of FIG. 22 according to another embodiment of the present general inventive concept. Defective nozzle detector 21 0C includes a first threshold comparator 700, a second threshold comparator 710, and a defective nozzle determiner 720.

Black and cyan may form a first chromatic image, and yellow and magenta may form a second chromatic image. When a reflectance of the first chromatic image including black and cyan with respect to a first light source is a first reflectance, a reflectance of the second chromatic image including yellow and magenta with respect to the first light source is a second reflectance, a reflectance of the first chromatic image including black and cyan with respect to the second light source is a third reflectance, the reflectance of the second chromatic image including yellow and magenta with respect to the second light source is a fourth reflectance, a reflectance of the first chromatic image including black and cyan with respect to the third light source is a fifth reflectance, and a reflectance of the second chromatic image including yellow and magenta with respect to the third light source is a sixth reflectance, the first threshold comparator 700 determines whether the third and fifth reflectances are greater than a first threshold reflectance and outputs the result of the determination to the second threshold comparator 710 and the defective nozzle determiner 720. The first threshold reflectance may be, for example, 75%.

The defective nozzle determiner 720 determines that a black nozzle to print black of the first chromatic image including black and cyan is a defective nozzle when the first threshold comparator 700 determines that the third to fifth reflectances are greater than the first threshold reflectance.

On the other hand, the reflectance comparator 710 determines whether the first reflectance is greater than a second threshold reflectance when the first threshold comparator 700 determines that either or both of the third to fifth reflectances are equal to or less than the first threshold reflectance, and outputs the result of the determination to the first threshold comparator 700 and the defective nozzle determiner 720. The second threshold reflectance may be, for example, 25%.

The defective nozzle determiner 720 determines that a cyan nozzle to print cyan of the first chromatic image including black and cyan is a defective nozzle when the second threshold comparator 710 determines that the first reflectance is greater than the second threshold reflectance.

In addition, the first threshold comparator 700 determines whether the second reflectance is greater than the first threshold reflectance when the second threshold comparator 710 determines that the first reflectance is equal to or less than the second threshold reflectance and outputs the result of the determination to the defective nozzle determiner 720.

The defective nozzle determiner 720 determines that a magenta nozzle to print magenta of the second chromatic image including yellow and magenta is a defective nozzle when the first threshold comparator 700 determines that the fourth reflectance is greater than the first threshold reflectance.

On the other hand, the first threshold comparator 700 determines whether the sixth reflectance is greater than the first threshold reflectance when the first threshold comparator 700 determines that the fourth reflectance is equal to or less than the first threshold reflectance and outputs the result of the determination to the defective nozzle determiner 720.

The defective nozzle determiner 720 determines that a yellow nozzle to print yellow of the second chromatic image including yellow and magenta is a defective nozzle when the first threshold comparator 700 determines that the sixth reflectance is greater than the first threshold reflectance.

In addition, the defective nozzle determiner 720 determines that the nozzles to print the first chromatic image including black and cyan and the second chromatic image including yellow and magenta are not defective nozzles when the first threshold comparator 700 determines that the sixth reflectance is equal to or less than the first threshold reflectance.

FIG. 28 is a block diagram illustrating the defective nozzle detector 210 of FIG. 22 according to another embodiment of the present general inventive concept. Defective nozzle detector 210D includes a first threshold comparator 800, a second threshold comparator 810, and a defective nozzle determiner 820.

Black and magenta may form a first chromatic image, and cyan and yellow may form a second chromatic image. When a reflectance of the first chromatic image including black and magenta with respect to a first light source is a first reflectance, a reflectance of the second chromatic image including cyan and yellow with respect to the first light source is a second reflectance, a reflectance of the first chromatic image including black and magenta with respect to the second light source is a third reflectance, a reflectance of the second chromatic image including cyan and yellow with respect to the second light source is a fourth reflectance, a reflectance of the first chromatic image including black and magenta with respect to the third light source is a fifth reflectance, and a reflectance of the second chromatic image including cyan and yellow with respect to the third light source is a sixth reflectance, the first threshold comparator 800 determines whether the first and fifth reflectances are greater than a first threshold reflectance and outputs the result of the determination to the second threshold comparator 810 and the defective nozzle determiner 820. The first threshold reflectance may be, for example, 75%.

The defective nozzle determiner 820 determines that a black nozzle to print black of the first chromatic image including black and magenta is a defective nozzle when the first threshold comparator 800 determines that the first and fifth reflectances are greater than the first threshold reflectance.

On the other hand, the second threshold comparator 810 determines whether the third reflectance is greater than a second threshold reflectance when the first threshold comparator 800 determines that either or both of the first and fifth reflectances are equal to or less than the first threshold reflectance, and outputs the result of the determination to the first threshold comparator 800 and the defective nozzle determiner 820. The second threshold reflectance may be, for example, 25%.

The defective nozzle determiner 820 determines that a magenta nozzle to print magenta of the second chromatic image including black and magenta is a defective nozzle when the second threshold comparator 810 determines that the third reflectance is greater than the second threshold reflectance.

In addition, the first threshold comparator 800 determines whether the second reflectance is greater than the first threshold reflectance when the second threshold comparator 810 determines that the third reflectance is equal to or less than the second threshold reflectance and outputs the result of the determination to the defective nozzle determiner 820.

The defective nozzle determiner 820 determines that a cyan nozzle to print cyan of the second chromatic image including cyan and yellow is a defective nozzle when the first threshold comparator 800 determines that the second reflectance is greater than the first threshold reflectance.

In addition, the first threshold comparator 800 determines whether the sixth reflectance is greater than the first threshold reflectance when first threshold comparator 800 determines that the second reflectance is equal to or less than the first threshold reflectance and outputs the result of the determination to the defective nozzle determiner 820.

The defective nozzle determiner 820 determines that a yellow nozzle to print yellow of the second chromatic image including cyan and yellow is a defective nozzle when the first threshold comparator 800 determines that the sixth reflectance is greater than the first threshold reflectance.

In addition, the defective nozzle determiner 820 determines that the nozzles to print the first chromatic image including black and cyan and the second chromatic image including yellow and magenta are not defective nozzles when the first threshold comparator 800 determines that the sixth reflectance is equal to or less than the first threshold reflectance.

A method and a device to detect defective nozzles of a wide array head according to various embodiments of the present general inventive concept can use a low resolution scanner as opposed to a high resolution scanner, which is required by prior art defective nozzle detection methods.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of detecting a defective nozzle of a wide array head, the method comprising:
printing a predetermined test pattern;
detecting reflectances of lights of first, second, and third light sources with respect to the test pattern by scanning the printed predetermined test pattern with the lights of the first, second, and third light sources; and
detecting a defective nozzle of the wide array head using each detected reflectance.

2. The method of claim 1, wherein the predetermined test pattern comprises a chromatic image including cyan, magenta, yellow, and black repeated at constant intervals.

3. The method of claim 2, wherein:
a line group image is an image in which the chromatic image is repeatedly printed in a main scanning direction; and
the predetermined test pattern includes at least eight line group images.

4. A computer-readable recording medium having embodied thereon a computer program to execute method of detecting a defective nozzle of a wide array head, the method comprising:
printing a predetermined test pattern;
detecting reflectances of first, second, and third light sources with respect to the test pattern by scanning the printed predetermined test pattern with the first, second, and third light sources; and
detecting a defective nozzle of the wide array head using each detected reflectance.

5. A device to detect a defective nozzle of a wide array head, the device comprising:
a test pattern detector to detect reflectances of lights of first, second, and third light sources by scanning a predetermined test pattern with the lights of the first, second, and third light sources; and
a defective nozzle detector to detect a defective nozzle using each detected reflectance.

6. The device of claim 5, wherein the predetermined test pattern comprises a chromatic image including cyan, magenta, yellow, and black repeated at constant intervals.

7. The device of claim 6, wherein:
a line group image is an image in which the chromatic image is repeatedly printed in a main scanning direction; and
the predetermined test pattern includes at least eight line group images.

8. The device of claim 7, wherein the test pattern detector comprises:
a light scanner to scan the line group images with the lights of the first, second, and third light sources; and
a reflectance detector to detect each reflectance of each chromatic image of the line group images with respect to the first, second, and third light sources.

9. The device of claim 5, wherein the predetermined test pattern comprises a chromatic image including two colors among selected from cyan, magenta, yellow, and black repeated at constant intervals.

10. The device of claim 9, wherein.
a line group image is an image in which the chromatic image is repeatedly printed in a main scanning direction; and
the predetermined test pattern includes at least eight line group images.

11. The device of claim 10, wherein the test pattern detector comprises:
a light scanner to scan the line group images with the first, second, and third light sources; and
a reflectance detector to detect each reflectance of the chromatic images of the line group images with respect to the first, second, and third light sources.

12. A method of detecting a defective nozzle in a printhead, the method comprising:
emitting first, second, and third color lights from first, second, and third light sources, respectively, towards a predetermined test pattern including at least one chromatic image;
detecting first, second, and third reflectances of the first, second, and third color lights, respectively, reflected from the at least one chromatic image; and
determining whether the printhead includes a defective nozzle using the first, second, and third reflectances and a predetermined threshold reflectance.

13. The method of claim 12, wherein the determining whether the printhead includes a defective nozzle comprises:
determining that the printhead does not include a defective nozzle when the first, second, and third reflectances are the same and are less than or equal to the predetermined threshold reflectance; and
determining that a black nozzle to print a black sub-image of the at least one chromatic image is a defective nozzle when the first, second, and third reflectances are the same and are greater than the predetermined threshold reflectance.

14. The method of claim 12, wherein the determining whether the printhead includes a defective nozzle comprises:
determining that a color nozzle to print a color sub-image of the at least one chromatic image is a defective nozzle when the first, second, and third reflectances are not the same.

15. The method of claim 14, wherein the determining whether the printhead includes a defective nozzle further comprises:
determining which of the first, second, and third reflectances has a greatest reflectance value; and
determining that a color nozzle to print a color corresponding to the first, second, or third reflectance having the greatest reflectance value is a defective nozzle.

16. The method of claim 12, wherein:
the emitting of the first, second, and third color lights comprises emitting the first, second, and third color lights towards a first chromatic image and a second chromatic image, respectively;
the detecting of the first, second, and third reflectances comprises detecting the first, second, and third reflectances reflected from the first chromatic image, and detecting fourth, fifth, and sixth reflectances reflected from the second chromatic image; and
the determining whether the printhead includes a defective nozzle comprises determining whether the printhead includes a defective nozzle using the first, second, third, fourth, fifth, and sixth reflectances and first and second predetermined threshold reflectances.

17. The method of claim 16, wherein the determining whether the printhead includes a defective nozzle comprises:
determining that a black nozzle to print a black sub-image of the first chromatic image is a defective nozzle when the first and second reflectances are greater than the predetermined threshold reflectance.

18. The method of claim 16, wherein the determining whether the printhead includes a defective nozzle comprises:
determining that a color nozzle to print a color sub-image of the first chromatic image is a defective nozzle when the first and second reflectances are less than the predetermined threshold reflectance and the third reflectance is greater than the second predetermined threshold reflectance.

19. The method of claim 16, wherein the determining whether the printhead includes a defective nozzle comprises:
determining that the printhead does not include a defective nozzle when the first, second, fourth, and fifth reflectances are less than or equal to the predetermined threshold reflectance, and the third reflectance is less than or equal to the second predetermined threshold reflectance.

20. The method of claim 16, wherein the determining whether the printhead includes a defective nozzle comprises:
determining that a color nozzle to print a color sub-image of the second chromatic image is a defective nozzle when the first and second reflectances are less than the predetermined threshold reflectance, the third reflectance is less than or equal to the second predetermined threshold reflectance, and one of the fourth, fifth, and sixth reflectances corresponding to the color sub-image of the second chromatic image is greater than the predetermined threshold reflectance.

21. An apparatus to detect a defective nozzle in a printhead, comprising:
first, second, and third light sources to emit first, second, and third color lights, respectively, towards a predetermined test pattern including at least one chromatic image;
a test pattern detector to detect first, second, and third reflectances of the first, second, and third color lights, respectively, reflected from the at least one chromatic image; and
a defective nozzle detector to determine whether the printhead includes a defective nozzle using the first, second, and third reflectances and a predetermined threshold reflectance.

22. The apparatus of claim 21, wherein the defective nozzle detector determines that the printhead does not include a defective nozzle when the first, second, and third reflectances are the same and are less than or equal to the predetermined threshold reflectance, and determines that a black nozzle to print a black sub-image of the at least one chromatic image is a defective nozzle when the first, second, and third reflectances are the same and are greater than the predetermined threshold reflectance.

23. The apparatus of claim 21, wherein the defective nozzle detector determines that a color nozzle to print a color sub-image of the at least one chromatic image is a defective nozzle when the first, second, and third reflectances are not the same.

24. The apparatus of claim 23, wherein the defective nozzle detector determines which of the first, second, and third reflectances has a greatest reflectance value, and determines that a color nozzle to print a color corresponding to the first, second, or third reflectance having the greatest reflectance value is a defective nozzle.

25. The apparatus of claim 21, wherein:
the first, second, and third light sources emit the first, second, and third color lights towards a first chromatic image and a second chromatic image, respectively;
the test pattern detector detects the first, second, and third reflectances reflected from the first chromatic image, and detects fourth, and fifth reflectances reflected from the second chromatic image; and
the defective nozzle detector determines whether the printhead includes a defective nozzle using the first, second, third, fourth, fifth, and sixth reflectances and the first and second predetermined threshold reflectances.

26. The apparatus of claim 25, wherein the defective nozzle detector determines that a black nozzle to print a black sub-image of the first chromatic image is a defective nozzle when the first and second reflectances are greater than the predetermined threshold reflectance.

27. The apparatus of claim 25, wherein the defective nozzle detector determines that a color nozzle to print a color sub-image of the first chromatic image is a defective nozzle when the first and second reflectances are less than the predetermined threshold reflectance and the third reflectance is greater than the second predetermined threshold reflectance.

28. The apparatus of claim 25, wherein the defective nozzle detector determines that the printhead does not include a defective nozzle when the first, second, fourth, and fifth reflectances are less than or equal to the predetermined threshold reflectance, and the third reflectance is less than or equal to the second predetermined threshold reflectance.

29. The apparatus of claim 25, wherein the defective nozzle detector determines that a color nozzle to print a color sub-image of the second chromatic image is a defective nozzle when the first and second reflectances are less than the predetermined threshold reflectance, the third reflectance is less than or equal to the second predetermined threshold reflectance, and one of the fourth, fifth, and sixth reflectances corresponding to the color sub-image of the second chromatic image is greater than the predetermined threshold reflectance.
